(19) United States
(12) Patent Application Publication
(10) Pub. No.: US 2003/0123075 A1
(43) Pub. Date: Jul. 3, 2003

(54) Network printing system

(76) Inventors: Ching-Ching Lin, Tai-Chung City (TW); Meng-Wen Pan, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,206

(22) Filed: Mar. 28, 2002

(30) Foreign Application Priority Data
Dec. 28, 2001 (TW) 090133003

(51) Int. Cl. B41B 1/00; G06F 15/00

(52) U.S. Cl. 358/1.13

(57) ABSTRACT

A netdeliver used in a network printing system is electrically connected to at least a computer and a printer. The netdeliver includes a plurality of printer profiles for driving a plurality of printers. Before sending an output to one of the printers, the netdeliver transforms image data of a document into a format consistent with a printer profile corresponding to the printer, and then outputs the transformed image data to the printer for printing.

### BACKGROUND OF INVENTION

1. Field of the Invention

The present invention relates to a network printing system, and more particularly, to a network printing system with a netdeliver (a device for delivering scanned images over a network).

2. Description of the Prior Art

As information develops day-by-day, printers are becoming an important output device for users in modern society. However, printers do not have uniform standards. Each of the different types of printers has a corresponding driving program. When users change to a new printer, a new driving program corresponding to the new printer must be installed in a computer so as to allow the new printer to receive data transmitted from the computer. This is an inconvenience for users.

Please refer to FIG. 1. FIG. 1 is a perspective view of a prior art network printing system 10. The network printing system 10 comprises a printer 12 for printing documents, a first computer 14, a network 16, and a second computer 18. The printer 12 is a general printer, which does not have network functionality. The first computer 14 is electrically connected to the printer 12 for acting as a print server of the printer 12. The network 16 is electrically connected between the first computer 14 and the second computer 18 for transmitting data between the first computer 14 and the second computer 18. The second computer 18 is electrically connected to the network 16 for transmitting data to the first computer 14 through the network 16. The data transmitted from the second computer 18 to the first computer 14 will be further transmitted to the printer 12 for printing.

Since the printer 12 does not have network functionality, the printer 12 must be electrically connected to the first computer 14 so as to make the first computer 14 act as the print server of the printer 12. Therefore, the second computer 18, electrically connected to the first computer 14 through network 16, is capable of transmitting data to the printer 12 through the first computer 14. A driving program 20 of the printer 12 is installed in the first computer 14 and the second computer 18 for driving the printer 12 so as to allow the printer 12 to receive data transmitted from the first computer 14 and the second computer 18. When the second computer 18 wants to print data through the printer 12, the second computer 18 performs image processing to transform data into image data consistent with a printer profile of the printer 12. The second computer 18 then performs printer language control to transform the image data into printing data which can be outputted to the printer 12. At last, the second computer 18, connected to the first computer 14 through network 16, transmits the printing data to the first computer 14, and then the first computer 14 further transmits the printing data to the printer 12 for printing.

Each printer has a corresponding driving program. If users change to a new printer, a new driving program corresponding to the new printer must be installed in the first computer 14 and the second computer 18 so as to allow the new printer to receive data transmitted from the first computer 14 and the second computer 18. This installation of the new driving program is an inconvenience for users.

Please refer to FIG. 2. FIG. 2 is a perspective view of another prior art network printing system 30. The network printing system 30 comprises a network printer 32, a network 34, and a computer 36. The network printer 32 comprises a print server 40, which gives the network printer 32 network functionality. The network 34 is electrically connected between the network printer 32 and the computer 36 for transmitting data between the network printer 32 and the computer 36. The computer 36 is electrically connected to the network for transmitting data to the network printer 32 through the network 34.

The network printer 32 has network functionality, such that the network printer 32 does not need to connect to the first computer 14 and use the first computer 14 as the print server, as was the case with the printer 12. A driving program 38 of the network printer 32 and installing software 42 of the print server 40 are installed in the computer 36 for driving the network printer 32 so as to allow the network printer 32 to receive data transmitted from the computer 36. When the computer 36 outputs data to the network printer 32, the computer 36 performs image processing to transform data into image data consistent with a printer profile corresponding to the network printer 32, and performs printer language control to transform image data into printing data that can be outputted to the network printer 32. At last, the computer 36 connected to the network printer 32 through network 34 transmits printing data to the network printer 32 for printing.

Similarly, if users change to a new network printer, a new driving program corresponding to the new network printer and a new installing software corresponding to a new print server must be installed in the computer 36 so as to allow the new network printer to receive data transmitted from the computer 36. Again, this is an inconvenience for users.

### SUMMARY OF INVENTION

It is therefore a primary objective of the claimed invention to provide a network printing system with a netdeliver, so that no additional driving program needs to be installed in computers when users change to new printers.

The claimed invention, briefly summarized, discloses a netdeliver used in a network printing system. The netdeliver is electrically connected to at least a computer and a printer. The netdeliver comprises a plurality of printer profiles for driving a plurality of printers. Before sending an output to one of the printers, the netdeliver transforms image data of a document into a format consistent with a printer profile corresponding to the printer, and then outputs the transformed image data to the printer for printing.

It is an advantage of the claimed invention that the computer of the claimed invention network printing system can output data to the printer by only installing a driving program of the netdeliver, and without the need to install the driving program of the printer. Therefore, the computer does not need other driving programs installed if users change to different printers.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a perspective view of a prior art network printing system.

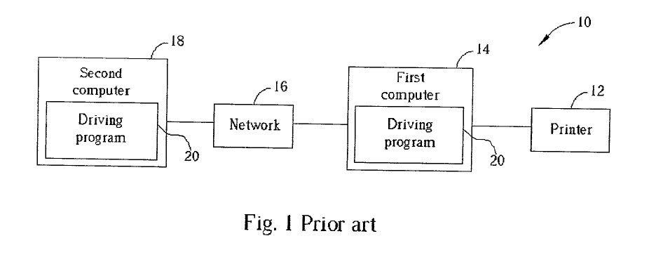

FIG. 2 is a perspective view of another prior art network printing system.

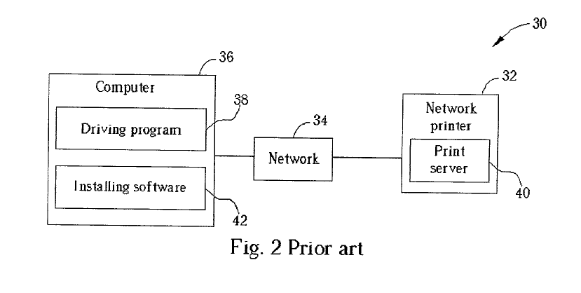

FIG. 3 is a perspective view of a present invention network printing system.

### DETAILED DESCRIPTION

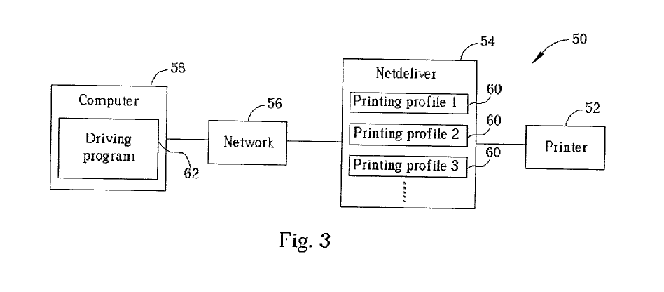

Please refer to FIG. 3. FIG. 3 is a perspective view of a present invention network printing system 50. The network printing system 50 comprises a computer 58 for processing data, a network 56, a netdeliver 54, and a printer 52. The network 56 is electrically connected between the computer 58 and the netdeliver 54 for transmitting data between the computer 58 and the netdeliver 54. The netdeliver 54 is electrically connected to the computer 58 through the network 56. A plurality of printer profiles 60 corresponding to a plurality of printers is stored in the netdeliver 54 for driving the plurality of printers. The printer 52 is electrically connected to the netdeliver 54 for printing data transmitted from the netdeliver 54.

The network printing system 50 further comprises a driving program 62 of the netdeliver 54. The driving program 62 is installed in the computer 58 for driving the netdeliver 54 so as to allow the netdeliver 54 to receive data transmitted from the computer 58. Before the computer 58 outputs data to the netdeliver 54, the netdeliver 54 transmits a printer profile 60 corresponding to the printer 52 to the computer 58 so that the computer 58 can transform data into image data consistent with the printer profile 60 of the printer 52. Then the computer 58 outputs image data to the netdeliver 54 through the network 56. The netdeliver 54 performs printer language control to transform image data outputted from the computer 58 into printing data. The netdeliver 54 outputs printing data to the printer 52 and then the printer 52 prints printing data.

The plurality of printer profiles 60 corresponding to the plurality of printers is stored inside the netdeliver 54. Before the computer 58 outputs data to the netdeliver 54, the netdeliver 54 transmits the printer profile 60 corresponding to the printer 52 to the computer 58 so that the computer 58 can transform data into image data according to the printer profile 60. Therefore, although users change to a new printer, no new driving program needs to be installed in the computer 58 since the netdeliver 54 already contains the plurality of printer profiles. If the printer profile is not located in the netdeliver 54, the computer 58 can transmit other printer profiles corresponding to other printers to the netdeliver 54 through the network 56. For example, when a new printer is installed or when users change to another printer, users only need to refresh the printer profile in the netdeliver once so as to allow the new printer to receive data transmitted from computers inside the network. The computers inside the network do not need to install a new driving program or a printer profile corresponding to the new printer. Additionally, although the printer 52 does not have network functionality, the printer 52 can electrically connect to the netdeliver 54 so as to further connect to the network 56. Therefore, the printer 52 does not need to connect to the first computer 14 and use the first computer 14 to be the print server, as was the case with the printer 12. The printer 52 of the present invention network printing system offers convenience for users.

In general, the image processing ability of the computer 58 is stronger than that of the netdeliver 54. Therefore, the computer 58 performs image processing to transform data into image data, and then sends the transformed image data to the netdeliver 54 through the network 56. The netdeliver 54 performs printer language control to transform image data transmitted from the computer 58 into printing data, and then sends the printing data to the printer 52 for printing. However, the netdeliver 54 can perform image processing instead of using the computer 58 to do the image processing. In this case, the netdeliver 54 will also then perform printer language control so as to transform image data into printing data. The printing data is sent to printer 52 for printing.

Actually, the netdeliver 54 is a scanner that can be used to scan documents. The scanner can perform image processing and printer language control according to the printer profile 60 corresponding to the printer 52 so as to transform scanning data into printing data. Then the scanner sends the transformed printing data to the printer 52 for printing.

In contrast to the prior art network printing system 10, 30, the present invention network printing system 50 includes the netdeliver 54. The netdeliver 54 contains the plurality of printer profiles corresponding to the plurality of printers. Therefore, the computer 58 can output data to the printer 52 only by installing the driving program 62 of the netdeliver 54, and does not need to install the driving program of the printer 52. Therefore, the computer 58 does not need to install new driving programs if users change to other new printers.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A netdeliver used in a network printing system, the netdeliver electrically connected to at least a computer and a printer, the netdeliver comprising a plurality of printer profiles for driving a plurality of printers;
wherein before sending an output to one of the printers, the netdeliver transforms image data of a document to a format consistent with a printer profile corresponding to the printer, and then outputs the transformed image data to the printer for printing.

2. The netdeliver of claim 1 wherein the network printing system further comprises a driving program installed inside the computer for driving the netdeliver so as to allow the netdeliver to receive image data transmitted from the computer.

3. The netdeliver of claim 1 wherein the netdeliver performs printer language control to transform image data transmitted from the computer into printing data, and then sends the printing data to the printer.

4. The netdeliver of claim 1 being a scanner, the scanner transforming the scanned image data to a format consistent with the printer profile corresponding to the printer, performing printer language control on the transformed image data in order to further transform the image data into printing data, and then sending the printing data to the printer.

5. The netdeliver of claim 1 wherein the plurality of printer profiles corresponding to the plurality of printers is stored inside the netdeliver.

6. The netdeliver of claim 1 wherein printer profiles corresponding to other printers are capable of being transmitted from the computer to the netdeliver through the network.

7. A network printing system comprising:
a computer for processing data;
a netdeliver electrically connected to the computer and comprising a plurality of printer profiles for driving a plurality of printers; and
a printer electrically connected to the netdeliver for printing data transmitted from the netdeliver;
wherein before receiving an output from the computer, the netdeliver transmits a printer profile corresponding to the printer to the computer so that the computer transforms an image data to a format consistent with the printer profile, and then outputs the transformed image data to the netdeliver.
